(19) United States
(12) Patent Application Publication
(10) Pub. No.: US 2008/0113641 A1
(43) Pub. Date: May 15, 2008

(54) RADIO COMMUNICATION APPARATUS AND FREQUENCY GENERATING METHOD THEREOF

(75) Inventors: Chan-young Jeong, Yongin-si (KR); Chang-sik Yoo, Yongin-si (KR); Jin-soo Park, Yongin-si (KR); Heung-bae Lee, Seongnam-si (KR); Young-eil Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/734,435

(22) Filed: Apr. 12, 2007

(30) Foreign Application Priority Data
Nov. 15, 2006 (KR) 2006-112933

(51) Int. Cl. H04B 1/26; H04B 15/00

(52) U.S. Cl. 455/315

(57) ABSTRACT

A radio communication apparatus and a frequency generating method thereof the communication apparatus including a frequency generator to generate a plurality of local oscillator (LO) frequencies; and a mixer to convert a frequency of an input signal by mixing the input signal with at least two of the LO frequencies generated by the frequency generator. As the LO frequencies are generated using the single VCO to support the radio communication standard of the multiple bands, the circuit area can be reduced and the multimode and multiband can be supported with one chip.

### CROSS-REFERENCE TO RELATED APPLICATION

This application claims the benefit of Korean Patent Application No. 2006-112933, filed on Nov. 15, 2006 in the Korean Intellectual Property Office, the disclosure of which is incorporated herein by reference.

### BACKGROUND OF THE INVENTION

1. Field of the Invention

Aspects of the present invention relate to a radio communication apparatus and a frequency generating method thereof, and more particularly, to a radio communication apparatus capable of supporting multimode and multiband using one chip, and a frequency generating method thereof.

2. Description of the Related Art

A complementary metal-oxide-semiconductor (CMOS) technique is suitable for the implementation of system-on-a-chip (SoC) in view of the integration as the chip size becomes smaller in the CMOS technique. With the smaller chip size, better radio frequency (RF) performance can be accomplished.

Meanwhile, different radio communication standards are emerging. Accordingly, radio communication devices are under development based on the various radio communication standards.

However, since the radio communication devices merely support a frequency band of their target radio communication standard, the radio communication devices require a radio communication transceiver that supports multiple bands based on the plurality of the radio communication standards so as to support various radio communication services. Typically, a structure of an integrated transceiver designed to support the various radio communication standards is divided into a direct-conversion and a dual-conversion.

FIG. 1 illustrates a structure of a conventional transceiver using the direct-conversion. Referring to FIG. 1, since two voltage-controlled oscillators (VCOs) are used, the circuit integration decreases, the circuit complexity increases, and the signal accuracy decreases.

In more detail, the direct-conversion receiver needs to use a quadrature structure for single side band (SSB). Hence, as several circuits are added, the circuit complexity increases. Also, since the inductor in the VCO is of a considerable size, when one or more VCOs are employed in the direct-conversion receiver, the circuit area increases. Like the receiver, the direct-conversion transmitter is also subject to the circuit integration decrease, the circuit complexity increase, and the signal accuracy decrease.

FIG. 2 illustrates a structure of a conventional dual-conversion transceiver. Referring to FIG. 2, the conventional dual-conversion transceiver down-converts the two received frequency bands (2.4 GHz and 5 GHz) to the same band (1.3˜1.5 GHz) using a first local oscillator (LO) frequency LO1, and down-converts the down-converted frequencies to a baseband using a second LO frequency LO2. However, when the dual-conversion transceiver down-converts the input signal using the plurality of the LOs, image generation is problematic.

That is, when the radio communication devices are to output the frequency of 2.4˜5 GHz band generally used, the frequency of the image generated during the dual conversion ranges from 900 MHz ˜1.8 GHz. Therefore, what is demanded is a considerable image rejection because the image is in the vicinity of the frequency most frequently used by the present-day radio communications.

### SUMMARY OF THE INVENTION

Aspects of the present invention provide a multimode and multiband communication apparatus that can generate an LO frequency using a single VCO to support radio communication standards of multiple bands, and a frequency generating method thereof.

According to an aspect of the present invention, there is provided a communication apparatus including a frequency generator to generate a plurality of local oscillator (LO) frequencies; and a mixer to convert a frequency of an input signal by mixing the input signal with at least two of the LO frequencies generated by the frequency generator.

The frequency generator may include a voltage-controlled oscillator (VCO) to output a preset oscillating voltage using a voltage applied from outside; and a frequency divider to generate first through fifth LO frequencies.

The mixer may down-convert the input signal of 0.6˜7.2 GHz band to a baseband signal by using combinations of (⅔, ⅓), (⅘, ⅕), and ( 8/9, 1/9) of the first through fifth LO frequencies.

The oscillating voltage may be 3.2˜4.8 GHz.

The frequency generator may set the oscillating voltage as a first LO frequency and provide the first LO frequency to the mixer.

The frequency generator may include: a first frequency divider to generate a second LO frequency of 1.6˜2.4 GHz by 2-dividing the oscillating voltage; a second frequency divider to generate a third LO frequency of 0.8˜1.2 GHz by 2-dividing the second LO frequency; a third frequency divider to generate a fourth LO frequency of 0.4˜0.6 GHz by 2-dividing the third LO frequency; and a fourth frequency divider to generate a fifth LO frequency of 0.2˜0.3 GHz by 2-dividing the fourth LO frequency.

The mixer may include a first mixer to down-convert the frequency of the input signal to an intermediate band by mixing the input signal with the LO frequency provided by the frequency generator; and a second mixer to down-convert the intermediate band signal to a baseband by mixing the intermediate band signal down-converted at the first mixer with the LO frequency provided by the frequency generator.

The first mixer may receive at least one of the first through fourth LO frequencies of the LO frequencies generated by the frequency generator, and mix and output the at least one of the first through fourth LO frequencies with the input signal, and the second mixer may receive at least one of the second through fifth LO frequencies of the LO frequencies generated by the frequency generator, and mix and output the at least one of the second through fifth LO frequencies with the intermediate band signal.

According to another aspect of the present invention, there is provided a frequency generating method including: generating a plurality of local oscillator (LO) frequencies; and converting a frequency of an input signal by mixing the input signal with at least two of the generated LO frequencies.

The generating of the plurality of LO frequencies may include outputting a preset oscillating voltage using a voltage applied from outside; and generating first through fifth LO frequencies.

The converting of the frequency may include down-converting the input signal of 0.6˜7.2 GHz band to a baseband signal by using combinations of (⅔, ⅓), (⅘, ⅕), and ( 8/9, 1/9) of the first through fifth LO frequencies.

The oscillating voltage may be 3.2˜4.8 GHz.

The generating of the plurality of LO frequencies may include setting the oscillating voltage as a first LO frequency and applying the first LO frequency to the converting operation.

The generating of the plurality of LO frequencies may include generating a second LO frequency of 1.6˜2.4 GHz by 2-dividing the oscillating voltage; generating a third LO frequency of 0.8˜1.2 GHz by 2-dividing the second LO frequency; generating a fourth LO frequency of 0.4˜0.6 GHz by 2-dividing the third LO frequency; and generating a fifth LO frequency of 0.2˜0.3 GHz by 2-dividing the fourth LO frequency.

The converting of the frequency may include: down-converting the frequency of the input signal to an intermediate band by mixing the input signal with an LO frequency; and down-converting the intermediate band signal to a baseband by mixing the down-converted intermediate band signal with an other LO frequency.

The down-converting of the frequency of the input signal may include receiving at least one of the first through fourth LO frequencies, and mixing and outputting the at least one of the first through fourth LO frequencies with the input signal; and the down-converting of the intermediate band signal may include receiving at least one of the second through fifth LO frequencies, and mixing and outputting the at least one of the second through fifth LO frequencies with the intermediate band signal.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a structure of a conventional direct-conversion transceiver;

FIG. 2 illustrates a conventional dual-conversion transceiver;

FIG. 3 is a block diagram of a receiver according to an embodiment of the present invention;

FIG. 4 is a block diagram of a frequency generator of the receiver according to an embodiment of the present invention; and

FIGS. 5A, 5B and 5C are flowcharts outlining a frequency generating method according to an embodiment of the present invention.

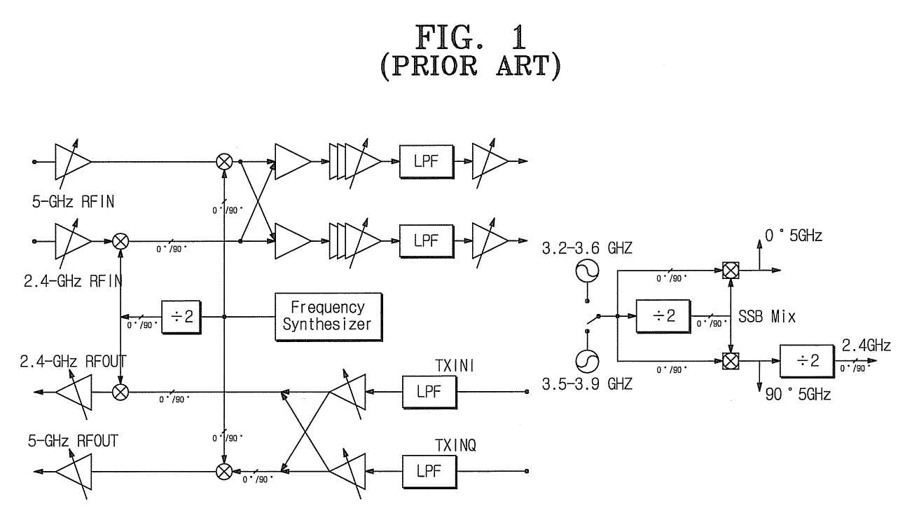

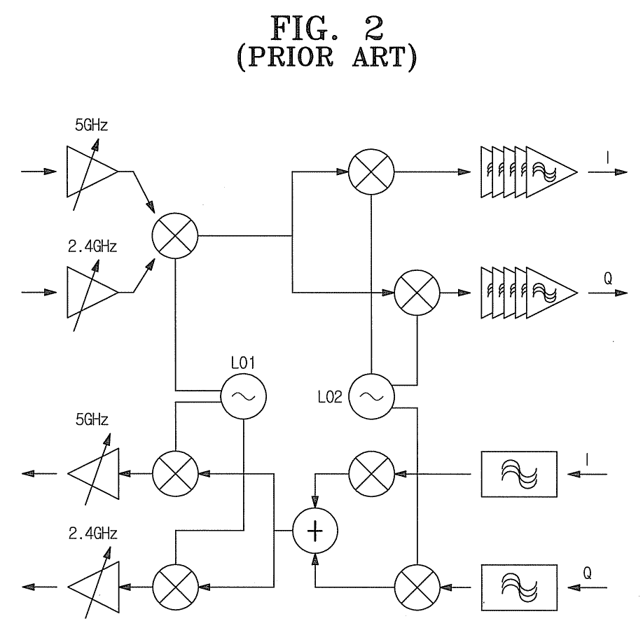

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

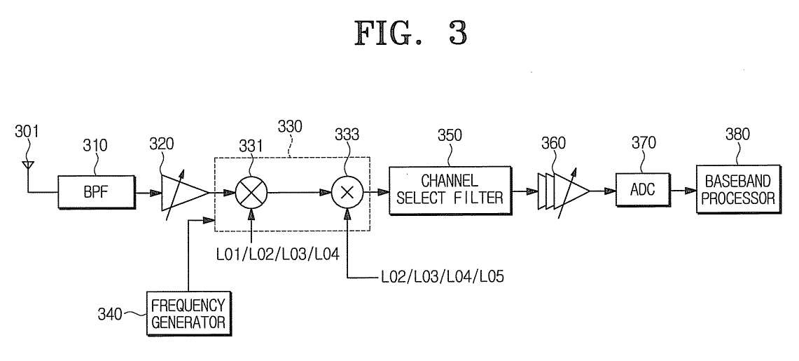

FIG. 3 is a block diagram of a receiver according to an embodiment of the present invention. The receiver may have two antennas, although not limited thereto. It is understood that more than two antennas can be employed. The antenna 301 may, although not necessarily, have band pass filter characteristics.

Referring to FIG. 3, the receiver includes a band pass filter (BPF) 310, a low noise amplifier (LNA) 320, a mixer 330, a frequency generator 340, a channel select filter 350, a power gain amplifier (PGA) 360, an analog-to-digital converter (ADC) 370, and a baseband processor 380.

The BPF 310 passes a signal within a specific range and rejects a signal outside of the specific range. While the receiver, according to an embodiment of the present invention, employs the sole antenna 301, it is understood that a plurality of antennas can be used. Accordingly, a plurality of the BPFs 310 can also be used.

The LNA 320 amplifies and outputs the signal fed from the BPF 310.

The mixer 330 generates and outputs a baseband frequency by mixing the signal fed from the LNA 320 with an LO frequency fed from the frequency generator 340. The mixer 330 includes first and second mixers 331 and 333.

The first mixer 331 down-converts the frequency of the signal fed from the LNA 320 to an intermediate band signal by mixing the signal fed from the LNA 320 with at least one of first through fourth LO frequencies (LO1, LO2, LO3, and LO4) provided by the frequency generator 340.

The second mixer 333 down-converts the frequency of the input signal to a baseband by mixing the signal input from the first mixer 331 with at least one of second through fifth LO frequencies (LO2, LO3, LO4, and LO5).

For example, when a signal of 4.8˜7.2 GHz band is input, the first mixer 331 down-converts the input signal to an intermediate band signal by mixing the input signal with the first LO frequency LO1 and the second mixer 333 down-converts the intermediate band signal to a baseband signal by mixing the down-converted intermediate band signal with the second LO frequency LO2.

For various radio frequency bands, in the same manner, the first and second mixers 331 and 333 down-convert the input signal to the baseband signal by mixing the input signal with the first through fifth LO frequencies (LO1, LO2, LO3, LO4, and LO5) corresponding to the frequency band of the input signal based on Table 1. Accordingly, the mixer 330 can down-convert the frequency of 0.6˜7.2 GHz band to the baseband signal using combinations of (⅔, ⅓), (⅘, ⅕), and ( 8/9, 1/9) of the first through fifth LO frequencies (LO1, LO2, LO3, LO4, and L05).

TABLE 1

| | |
|---|---|
| first LO frequency + second LO frequency | 4.8~7.2 GHz |
| first LO frequency + third LO frequency | 4.0~6.0 GHz |
| first LO frequency + fourth LO frequency | 3.6~5.4 GHz |
| second LO frequency + third LO frequency | 2.4~3.6 GHz |
| second LO frequency + fourth LO frequency | 2.0~3.0 GHz |
| second LO frequency + fifth LO frequency | 1.8~2.7 GHz |
| third LO frequency + fourth LO frequency | 1.2~1.8 GHz |
| third LO frequency + fifth LO frequency | 1.0~1.5 GHz |
| fourth LO frequency + fifth LO frequency | 0.6~0.9 GHz |

The frequency generator 340 generates and outputs the first through fifth LO frequencies (LO1, LO2, LO3, LO4, and LO5) to the mixer 330.

The channel select filter 350 passes a signal in a channel within a specific range and rejects a signal outside of the specific range. The channel select filter 350 may include a first channel filter and a second channel filter (not shown). That is, the channel select filter 350 passes a signal in a channel of the intended band. In doing so, the first and second channel filters (not shown) pass a signal in channels corresponding to 2.4 GHz and 5˜6 GHz bands, respectively, and reject other channels. However, it is understand that the signal is not limited to 2.4 GHz and 5˜6 GHz bands.

The PGA 360 may include a first and second PGA (not shown), and adjusts the gain of the signal fed from the channel select filter 350 to a preset reference gain and outputs the gain-adjusted signal. A first PGA (not shown) adjusts the gain of the signal fed from the first channel filter (not shown) to a reference gain, and a second PGA (not shown) adjusts the gain of the signal fed from the second channel filter (not shown) to a reference gain. Herein, the reference gain can be preset to not only a specific value, but a specific range.

The ADC 370 includes first and second ADCs (not shown). The first and second ADCs (not shown) convert the analogs signals fed from the first and second PGAs (not shown) to digital signals, respectively.

The baseband processor 380 modulates and demodulates the digital signal fed from the ADC 370 and outputs the processed signal.

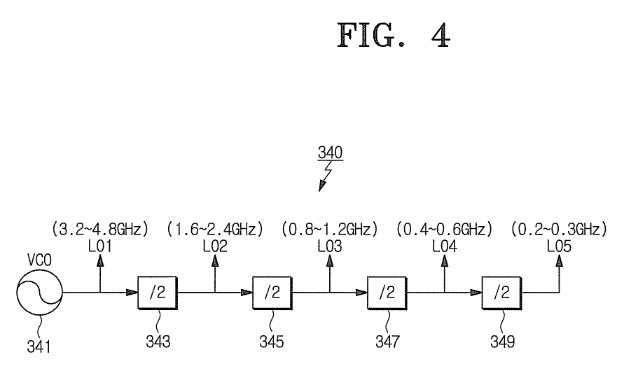

FIG. 4 is a block diagram of the frequency generator of the receiver according to an embodiment of the present invention. Referring to FIG. 4, the frequency generator 340 includes a VCO 341 and first through fourth frequency dividers 343, 345, 347, and 349. The frequency generator 340 generates first through fifth LO frequencies (LO1, LO2, LO3, LO4, and LO5) using the VCO 341 and the first through fourth frequency dividers 343, 345, 347, and 349, and then outputs the generated first through fifth LO frequencies (LO1, LO2, LO3, LO4, and LO5) to the mixer 330. It is understood that the frequency generator 340 may include a phase locked loop (PLL), which is not shown.

The VCO 341 outputs as a preset oscillating voltage using a voltage applied from outside. At this time, the frequency generator 340 sets the oscillating voltage output from the VCO 341 to the first LO frequency LO1 and provides the first LO frequency LO1 to the first mixer 331.

The oscillating voltage output from the VCO 341 may range between 3.2˜4.8 GHz, although not limited thereto. For the current description, an example of a first LO frequency having a range of 3.2˜4.8 GHz will be used.

The first frequency divider 343 generates a second LO frequency LO2 by 2-dividing the frequency 3.2˜4.8 GHz of the oscillating voltage fed from the VCO 341. That is, the second LO frequency LO2 is 1.6˜2.4 GHz. The frequency generator 340 provides the generated second LO frequency LO2 to the first mixer 331 and the second mixer 333.

The second frequency divider 345 generates a third LO frequency LO3 by 2-dividing the second LO frequency LO2 1.6˜2.4 GHz fed from the first frequency divider 343. Hence, the third LO frequency LO3 is 0.8˜1.2 GHz. The frequency generator 340 applies the generated third LO frequency LO3 to the first mixer 331 and the second mixer 333.

The third frequency divider 347 generates a fourth LO frequency LO4 by 2-dividing the third LO frequency LO3 0.8˜1.2 GHz fed from the second frequency divider 345. Hence, the fourth LO frequency LO4 is 0.4˜0.6 GHz. The frequency generator 340 applies the generated fourth LO frequency LO4 to the first mixer 331 and the second mixer 333.

The fourth frequency divider 349 generates a fifth LO frequency LO5 by 2-dividing the fourth LO frequency LO4 0.4˜0.6 GHz fed from the third frequency divider 347. Hence, the fifth LO frequency LO5 is 0.2˜0.3 GHz. The frequency generator 340 applies the generated fifth LO frequency LO5 to the second mixer 333.

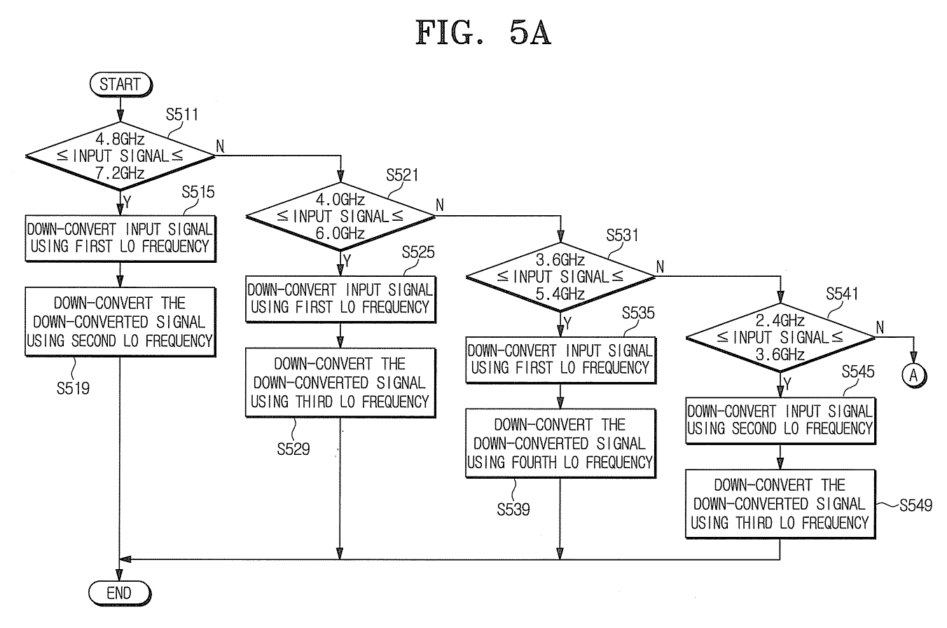

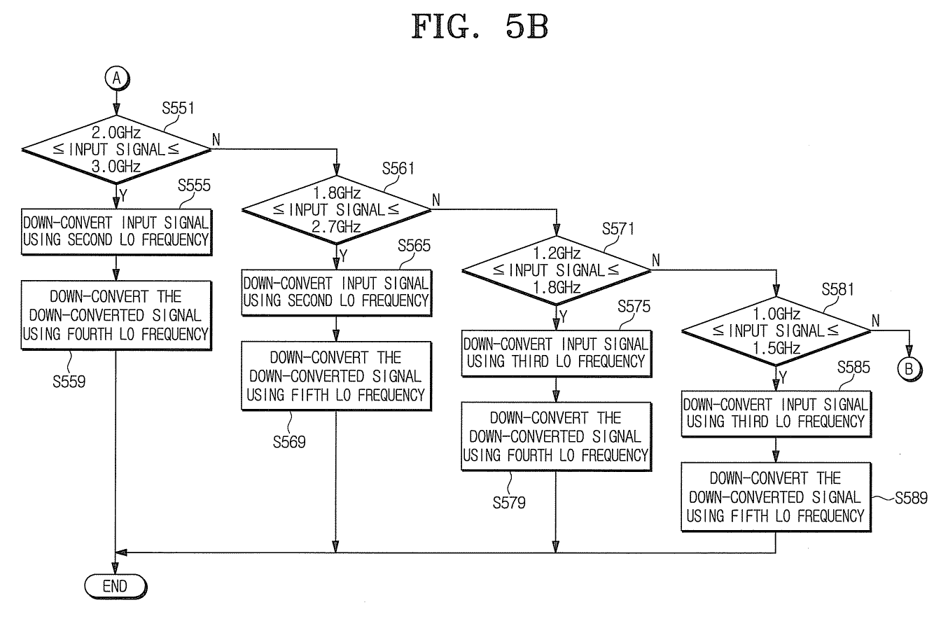

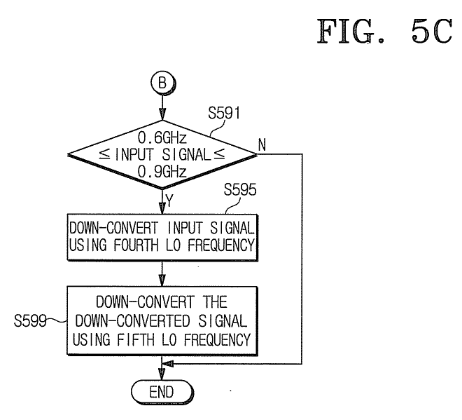

FIGS. 5A, 5B and 5C are flowcharts outlining a frequency generating method according to an embodiment of the present invention. Referring now to FIGS. 5A, 5B, and 5C, when a signal of 4.8˜7.2 GHz band is received in operation S511, the first mixer 331 down-converts the input signal to an intermediate band signal by mixing the received signal of 4.8˜7.2 GHz with the first LO frequency LO1 3.2˜4.8 GHz provided from the frequency generator 340 in operation S515.

Next, the second mixer 333 down-converts the signal down-converted at the first mixer 331 to a baseband signal by mixing the signal with the second LO frequency LO2 1.6˜2.4 GHz provided from the frequency generator 340 in operation S519.

When a signal of 4.0˜6.0 GHz band is received in operation S521, the first mixer 331 down-converts the input signal to an intermediate band signal by mixing the received signal of 4.0˜6.0 GHz with the first LO frequency LO1 3.2˜4.8 GHz provided from the frequency generator 340 in operation S525.

Next, the second mixer 333 down-converts the signal down-converted at the first mixer 331 to a baseband signal by mixing the signal with the third LO frequency LO3 0.8˜1.2 GHz provided from the frequency generator 340 in operation S529.

When a signal of 3.6˜5.4 GHz band is received in operation S531, the first mixer 331 down-converts the input signal to an intermediate band signal by mixing the received signal of 3.6˜5.4 GHz with the first LO frequency LO1 3.2˜4.8 GHz provided from the frequency generator 340 in operation S535.

Next, the second mixer 333 down-converts the signal down-converted at the first mixer 331 to a baseband signal by mixing the signal with the fourth LO frequency LO4 0.4˜0.6 GHz provided from the frequency generator 340 in operation S539.

When a signal of a 2.4˜3.6 GHz band is received in operation S541, the first mixer 331 down-converts the input signal to an intermediate band signal by mixing the received signal of 2.4˜3.6 GHz with the second LO frequency LO2 1.6˜2.4 GHz provided from the frequency generator 340 in operation S545.

Next, the second mixer 333 down-converts the signal down-converted at the first mixer 331 to a baseband signal by mixing the signal with the third LO frequency LO3 0.8˜1.2 GHz provided from the frequency generator 340 in operation S549.

When a signal of 2.0˜3.0 GHz band is received in operation S551, the first mixer 331 down-converts the input signal to an intermediate band signal by mixing the received signal of 2.0˜3.0 GHz with the second LO frequency LO2 1.6˜2.4 GHz provided from the frequency generator 340 in operation S555.

Next, the second mixer 333 down-converts the signal down-converted at the first mixer 331 to a baseband signal by mixing the signal with the fourth LO frequency LO4 0.4˜0.6 GHz provided from the frequency generator 340 in operation S559.

When a signal of 1.8˜2.7 GHz band is received in operation S561, the first mixer 331 down-converts the input signal to an intermediate band signal by mixing the received signal of 1.8˜2.7 GHz with the second LO frequency LO2 1.6˜2.4 GHz provided from the frequency generator 340 in operation S565.

Next, the second mixer 333 down-converts the signal down-converted at the first mixer 331 to a baseband signal by mixing the signal with the fifth LO frequency LO5 0.2˜0.3 GHz provided from the frequency generator 340 in operation S569.

When a signal of 1.2˜1.8 GHz band is received in operation S571, the first mixer 331 down-converts the input signal to an intermediate band signal by mixing the received signal of 1.2˜1.8 GHz with the third LO frequency LO3 0.8˜1.2 GHz provided from the frequency generator 340 in operation S575.

Next, the second mixer 333 down-converts the signal down-converted at the first mixer 331 to a baseband signal by mixing the signal with the fourth LO frequency LO4 0.4˜0.6 GHz provided from the frequency generator 340 in operation S579.

When a signal of 1.0˜1.5 GHz band is received in operation S581, the first mixer 331 down-converts the input signal to an intermediate band signal by mixing the received signal of 1.0˜1.5 GHz with the third LO frequency LO3 0.8˜1.2 GHz provided from the frequency generator 340 in operation S585.

Next, the second mixer 333 down-converts the signal down-converted at the first mixer 331 to a baseband signal by mixing the signal with the fifth LO frequency LO5 0.2˜0.3 GHz provided from the frequency generator 340 in operation S589.

When a signal of 0.6˜0.9 GHz band is received in operation S591, the first mixer 331 down-converts the input signal to an intermediate band signal by mixing the received signal of 0.6˜0.9 GHz with the fourth LO frequency LO4 0.4˜0.6 GHz provided from the frequency generator 340 in operation S595.

Next, the second mixer 333 down-converts the signal down-converted at the first mixer 331 to a baseband signal by mixing the signal with the fifth LO frequency LO5 0.2˜0.3 GHz provided from the frequency generator 340 in operation S599.

Although the frequency generator and the mixer have been described as applied in a receiver, it is understood that the frequency generator and the mixer are not limited thereto and, for example, may be applicable to a transmitter.

Although the frequency generator has been described to generate the five LO frequencies (LO1, LO2, LO3, LO4, and LO5) using the one VCO and the four frequency dividers, it is understood that the numbers of the frequency dividers and the LO frequencies are not limited thereto. By increasing the number of the frequency dividers, it is possible to generate a plurality of LO frequencies to handle signals of the frequency band below 0.6 GHz. In addition, by raising the oscillating voltage produced at the VCO 341, it is possible to generate a plurality of LO frequencies capable of handling signals of high frequency band over 7.2 GHz (such as UWB).

In light of the foregoing, as the LO frequencies are generated using the single VCO to support the radio communication standard of the multiple bands, the circuit area can be reduced and the multimode and multiband can be supported with one chip.

Additionally, by combining and providing the LO frequencies generated to support the multiband, the image is generated in a frequency band which is not frequently used in the radio communication. Therefore, the image can be greatly suppressed in the communication apparatus.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A communication apparatus comprising:
a frequency generator to generate a plurality of local oscillator (LO) frequencies; and
a mixer to convert a frequency of an input signal by mixing the input signal with at least two of the LO frequencies generated by the frequency generator.

2. The communication apparatus as claimed in claim 1, wherein the frequency generator comprises:
a voltage-controlled oscillator (VCO) to output a preset oscillating voltage using a voltage applied from outside.

3. The communication apparatus as claimed in claim 1, wherein the frequency generator comprises:
one or more frequency dividers to generate the plurality of LO frequencies.

4. The communication apparatus as claimed in claim 3, wherein the one or more frequency dividers generate five LO frequencies.

5. The communication apparatus as claimed in claim 4, wherein the mixer down-converts an input signal of 0.6˜7.2 GHz band to a baseband signal by using combinations of a first LO frequency and a second LO frequency, the first LO frequency and a third LO frequency, the first LO frequency and a fourth LO frequency, the second LO frequency and the third LO frequency, the second LO frequency and the fourth LO frequency, the second LO frequency and a fifth LO frequency, the third LO frequency and the fourth LO frequency, the third LO frequency and the fifth LO frequency, or the fourth LO frequency and the fifth LO frequency.

6. The communication apparatus as claimed in claim 2, wherein the oscillating voltage is 3.2˜4.8 GHz.

7. The communication apparatus as claimed in claim 2, wherein the frequency generator sets the oscillating voltage as a first LO frequency and provides the first LO frequency to the mixer.

8. The communication apparatus as claimed in claim 7, wherein the frequency generator comprises:
a first frequency divider to generate a second LO frequency of 1.6˜2.4 GHz by 2-dividing the oscillating voltage;
a second frequency divider to generate a third LO frequency of 0.8˜1.2 GHz by 2-dividing the second LO frequency;
a third frequency divider to generate a fourth LO frequency of 0.4˜0.6 GHz by 2-dividing the third LO frequency; and
a fourth frequency divider to generate a fifth LO frequency of 0.2˜0.3 GHz by 2-dividing the fourth LO frequency.

9. The communication apparatus as claimed in claim 1, wherein the mixer comprises:
a first mixer to down-convert the frequency of the input signal to an intermediate band by mixing the input signal with one of the LO frequencies provided by the frequency generator; and
a second mixer to down-convert the intermediate band signal to a baseband by mixing the intermediate band signal with another one of the LO frequencies provided by the frequency generator.

10. The communication apparatus as claimed in claim 9, wherein:
the first mixer receives at least one of a first LO frequency, a second LO frequency, a third LO frequency, and a fourth LO frequency from the frequency generator, and mixes and outputs the at least one of the first, the second, the third, and the fourth LO frequencies with the input signal; and
the second mixer receives at least one of the second LO frequency, the third LO frequency, the fourth LO frequency, and a fifth LO frequency from the frequency generator, and mixes and outputs the at least one of the second, the third, the fourth, and the fifth LO frequencies with the intermediate band signal.

11. The communication apparatus as claimed in claim 1, wherein the communication apparatus is a receiver.

12. The communication apparatus as claimed in claim 1, wherein the communication apparatus is a transmitter.

13. A frequency generating method comprising:
generating a plurality of local oscillator (LO) frequencies; and
converting a frequency of an input signal by mixing the input signal with at least two of the generated LO frequencies.

14. The frequency generating method as claimed in claim 16, wherein the generating of the plurality of LO frequencies comprises:
outputting a preset oscillating voltage using a voltage applied from outside.

15. The frequency generating method as claimed in claim 16, wherein the generating of the plurality of LO frequencies comprises:
generating five LO frequencies.

16. The frequency generating method as claimed in claim 15, wherein the converting of the frequency comprises:
down-converting the input signal of 0.6˜7.2 GHz band to a baseband signal by using combinations of a first LO frequency and a second LO frequency, the first LO frequency and a third LO frequency, the first LO frequency and a fourth LO frequency, the second LO frequency and the third LO frequency, the second LO frequency and the fourth LO frequency, the second LO frequency and a fifth LO frequency, the third LO frequency and the fourth LO frequency, the third LO frequency and the fifth LO frequency, or the fourth LO frequency and the fifth LO frequency.

17. The frequency generating method as claimed in claim 14, wherein the oscillating voltage is 3.2˜4.8 GHz.

18. The frequency generating method as claimed in claim 14, wherein the generating of the plurality of LO frequencies further comprises:
setting the oscillating voltage as a first LO frequency and applying the first LO frequency to the converting of the frequency.

19. The frequency generating method as claimed in claim 18, wherein the generating of the plurality of LO frequencies further comprises:
generating a second LO frequency of 1.6˜2.4 GHz by 2-dividing the oscillating voltage;
generating a third LO frequency of 0.8˜1.2 GHz by 2-dividing the second LO frequency;
generating a fourth LO frequency of 0.4˜0.6 GHz by 2-dividing the third LO frequency; and
generating a fifth LO frequency of 0.2˜0.3 GHz by 2-dividing the fourth LO frequency.

20. The frequency generating method as claimed in claim 13, wherein the converting of the frequency comprises:
down-converting the frequency of the input signal to an intermediate band by mixing the input signal with one of the generated LO frequencies; and
down-converting the intermediate band signal to a baseband by mixing the down-converted intermediate band signal with another one of the generated LO frequencies.

21. The frequency generating method as claimed in claim 20, wherein:
the down-converting of the frequency of the input signal to the intermediate band comprises:
receiving at least one of a first LO frequency, a second LO frequency, a third LO frequency, and a fourth LO frequency, and
mixing and outputting the at least one of the first LO frequency, the second LO frequency, the third LO frequency, and the fourth LO frequency with the input signal, and
the down-converting of the intermediate band comprises:
receiving at least one of the second LO frequency, the third LO frequency, the fourth LO frequency, and a fifth LO frequency, and
mixing and outputting the at least one of the second LO frequency, the third LO frequency, the fourth LO frequency, and the fifth LO frequency with the intermediate band signal.

22. A communication apparatus comprising:
a mixer to convert a frequency of an input signal by mixing the input signal with at least two LO frequencies.

23. The communication apparatus as claimed in claim 22, further comprising:
a frequency generator to generate the at least two LO frequencies.

24. The communication apparatus as claimed in claim 23, wherein the frequency generator comprises:
a voltage-controlled oscillator (VCO) to output a preset oscillating voltage using a voltage applied from outside.

25. The communication apparatus as claimed in claim 23, wherein the frequency generator comprises:
one or more frequency dividers to generate the plurality of LO frequencies.

26. The communication apparatus as claimed in claim 22, wherein the mixer down-converts an input signal of 0.6˜7.2 GHz band to a baseband signal by using combinations of a first LO frequency and a second LO frequency, the first LO frequency and a third LO frequency, the first LO frequency and a fourth LO frequency, the second LO frequency and the third LO frequency, the second LO frequency and the fourth LO frequency, the second LO frequency and a fifth LO frequency, the third LO frequency and the fourth LO frequency, the third LO frequency and the fifth LO frequency, or the fourth LO frequency and the fifth LO frequency.

27. The communication apparatus as claimed in claim 24, wherein the oscillating voltage is 3.2˜4.8 GHz.

28. The communication apparatus as claimed in claim 24, wherein the frequency generator sets the oscillating voltage as a first LO frequency and provides the first LO frequency to the mixer.

29. The communication apparatus as claimed in claim 28, wherein the frequency generator comprises:
a first frequency divider to generate a second LO frequency of 1.6˜2.4 GHz by 2-dividing the oscillating voltage;
a second frequency divider to generate a third LO frequency of 0.8˜1.2 GHz by 2-dividing the second LO frequency;
a third frequency divider to generate a fourth LO frequency of 0.4˜0.6 GHz by 2-dividing the third LO frequency; and
a fourth frequency divider to generate a fifth LO frequency of 0.2˜0.3 GHz by 2-dividing the fourth LO frequency.

30. The communication apparatus as claimed in claim 22, wherein the mixer comprises:
a first mixer to down-convert the frequency of the input signal to an intermediate band by mixing the input signal with one of the LO frequencies provided by the frequency generator; and
a second mixer to down-convert the intermediate band signal to a baseband by mixing the intermediate band signal with another one of the LO frequencies provided by the frequency generator.

31. The communication apparatus as claimed in claim 30, wherein:
the first mixer receives at least one of a first LO frequency, a second LO frequency, a third LO frequency, and a fourth LO frequency from the frequency generator, and mixes and outputs the at least one of the first, the second, the third, and the fourth LO frequencies with the input signal; and
the second mixer receives at least one of the second LO frequency, the third LO frequency, the fourth LO frequency, and a fifth LO frequency from the frequency generator, and mixes and outputs the at least one of the second, the third, the fourth, and the fifth LO frequencies with the intermediate band signal.

32. The communication apparatus as claimed in claim 22, wherein the communication apparatus is a receiver.

33. The communication apparatus as claimed in claim 22, wherein the communication apparatus is a transmitter.

34. A communication apparatus comprising:
a single voltage-controlled oscillator (VCO) to output a preset oscillating voltage using a voltage applied from outside to generate a plurality of local oscillator (LO) frequencies; and
a mixer to convert a frequency of an input signal by mixing the input signal with at least two of the generated LO frequencies.
